(19) United States
(12) Patent Application Publication
(10) Pub. No.: US 2007/0183320 A1
(43) Pub. Date: Aug. 9, 2007

(54) Deficit fair priority queuing

(76) Inventors: Jian Feng Chen, Beijing (CN); Wen Hua Jiao, Beijing (CN); Hong Xi Wang, Beijing (CN)

Correspondence Address: CARLSON, GASKEY & OLDS, P.C., 400 W MAPLE RD, SUITE 350, BIRMINGHAM, MI, 48009, US

(21) Appl. No.: 11/350,196

(22) Filed: Feb. 8, 2006

(51) Int. Cl. H04L 12/56; H04L 12/26

(52) U.S. Cl. 370/229; 370/395.42

(57) ABSTRACT

A deficit fair priority queue scheduling technique includes arranging connections in a waiting queue according to a plurality of priority classes including a first class having a higher priority than a second class. Each time a scheduler visits a queue having waiting connections, a deficit value for each priority class is initialized and used to determine how many bandwidth request packets for that class will be serviced in a round. The highest priority packets will be serviced until the deficit value for that class falls below a selected threshold or there are no remaining waiting packets of that class. Within the same round, the scheduler can service lower priority connections until the deficit value for that service class is below the threshold or there are no remaining packets of that class. Because the lower class packets have a chance of being serviced before all higher priority class packets have been serviced, the disclosed example is a deficit fair priority queuing technique.

### FIELD OF THE INVENTION

This invention generally relates to communication. More particularly, this invention relates to scheduling transmissions for communications.

### DESCRIPTION OF THE RELATED ART

Various communication systems are known. One example is the IEEE 802.16 standard based broadband wireless communication, which provides a cost-effective way to deploy applications in licensed bands in the 10 to 66 GHz frequency range and non-line of sight (NLOS) applications in licensed and unlicensed bands in the sub 11 GHz frequency range. Under point to multipoint (PMP) mode, the IEEE 802.16 standard includes a connection-oriented MAC protocol, in which a mechanism for quality of service guarantee between a base station and multiple subscriber stations, such as the connection set-up, bandwidth request and distribution is defined. The scheduling algorithms which determine the uplink and downlink bandwidth allocation in a single frame, however, are left undefined.

There are various known scheduling techniques that have been used in different communication contexts. One technique is known as first in, first out (FIFO) or first-come, first-served (FCFS) queuing. This can be regarded as the simplest scheduling method. Packets are placed into a single queue and serviced in the order of their arrival. There are obvious limitations to such a queuing technique.

Another known technique is referred to as priority queuing (PQ) where each packet is assigned a priority and placed into a hierarchy of queues based on priority. The highest priority queue is serviced first. After there are no more packets in a highest priority queue, the next-lower queue is serviced. A significant drawback associated with this technique is that lower-priority packets may receive little or no attention for considerable periods of time.

Another example technique, which attempts to address the shortcomings of FIFO and PQ, is fair queuing (FQ). With this technique, each packet is assigned a type or flow and placed into the queue for the corresponding type. All queues are serviced round-robin in which a packet from one queue is serviced, a packet from the next queue and so on. FQ techniques provide a more uniform service to all packet types than priority queuing techniques. A drawback with fair queuing, however, is that quality of service for higher priority packets cannot be guaranteed.

One attempt at improving queuing is known as weighted fair queuing (WFQ). This technique is similar to FQ except that queues are assigned priorities and can support variable-length packets. Another technique is known as hierarchical weighted fair queuing (HWFQ). This is similar to WFQ but adjustments to queues are made based upon monitored traffic and evaluated current conditions. An example HWFQ technique uses worst-case packet delay as the evaluation metric.

Another technique is known as weighted round-robin (WRR). This technique is similar to FQ in that packets are assigned a class (e.g., real time, file transfer, etc.) and placed into the queue for that class of service. Packets are accessed round-robin style, but classes can be given priorities. For example, four packets from a high-priority class might be serviced, followed by two from a middle-priority class and then one from a low-priority class. This type of queuing is sometimes known as class-based queuing (CBQ) or custom queuing (CQ).

Another technique is known as deficit weighted round-robin (DWRR). This technique is a weighted round-robin method that uses a deficit counter. In the classic DWRR algorithm, the scheduler visits each non-empty queue and determines the number of bits in the packet at the head of the queue. A maximum packet size number is subtracted from the packet length and packets that exceed that number are held back until the next visit of the scheduler to the queue containing such packets. This is a priority queuing technique, which includes the possibility that lower priority queues will not be serviced for a considerable time when the deficit counter is much smaller than the average packet length in low priority queue.

With the drawbacks associated with each of the queuing techniques described above, there is a need for an improved scheduling approach. This invention addresses that need.

### SUMMARY OF THE INVENTION

An exemplary method of communicating includes scheduling packets for transmission using deficit fair priority queuing.

One example includes arranging packets waiting for service according to a plurality of priority classes. A first class has a higher priority than a second class. A first class deficit value is determined. Any waiting first class packets are serviced before serving any second class packets until at least one of the first class deficit value, which is decreased at each serviced packet, is below a selected threshold or there is no remaining waiting first class packet. After the first class deficit value is below the selected threshold or there is no remaining waiting first class packet, a second class deficit value is determined. Any waiting second class packets are then serviced until at least one of the second class deficit value, which is decreased at each serviced packet, is below a selected threshold or there is no remaining waiting second class packet.

One example includes initializing the first class deficit value in an amount corresponding to the first class before servicing any of the first class packets. The first class deficit value is decreased each time that a first class packet is serviced in an amount corresponding to a bandwidth requirement of the serviced first class packet. Subsequent to serving the last of the service first class packets, the second class deficit value is initialized in an amount corresponding to the second class for serving any of the second class packets. The deficit value is decreased each time that a second class packet is serviced in an amount corresponding to a bandwidth requirement of the serviced second class packet.

The fairness among different priority services is improved since the lower class packets have a chance of being serviced before all higher priority class packets have been serviced.

In one example, waiting packets are serviced until the capacity of a frame is reached or it becomes necessary to send a MAP message.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 is a flowchart diagram summarizing one example approach for using deficit fair priority queuing.

FIG. 2 graphically illustrates one exampled implementation of the approach summarized in Figure

### DETAILED DESCRIPTION

This invention is a hierarchical scheduling structure that uses a combination of deficit fair priority queuing (DFPQ) for multiple service flows. The terms “deficit fair priority queuing” are used in this description to refer to a scheduling technique that arranges packets in queues according to priority, services higher priority packets first until their assigned bandwidth is deficit and is fair because lower priority packets have a chance of being serviced within a service round even before all the higher priority packets have been serviced. This is distinct from a strict priority queuing technique where lower priority packets are not serviced until after all higher priority packets have been serviced. In a disclosed example, quality of service management is achieved by utilizing an admission control strategy, buffer management strategy and a scheduling technique that includes DFPQ.

One context in which the disclosed example can be used is an IEEE 802.16 MAC protocol, which is connection oriented. In such an example, the application establishes a connection with a base station and the associated service flow. The base station will assign the connection with a unique connection ID to each uplink or downlink transmission. When a new service flow generates or updates its parameters, it sends a message (e.g., a dynamic service addition or dynamic service change message) to the base station. Then the admission control determines whether this request will be approved. A bandwidth request will be sent out for each flow. All bandwidth requests from the services are classified by the connection classifier based on the connection ID and the service type. The requests are then forwarded to the appropriate queue. A scheduling module retrieves the requests from the queues and generates Uplink Map (UL-MAP) and Downlink Map (DL-MAP) messages according to the bandwidth allocations results.

For purposes of discussion, an example having three types of service flows is considered. One type is known as real-time polling service (rtPS). A second type is known as non-real-time polling service (nrtPS). A third type is best effort (BE) service.

In one example, a hierarchical structure of the bandwidth allocation is useful for time division duplexing (TDD) mode. In one example, six queues are defined according to their direction (e.g., uplink or downlink) and the service class. In this example, the service-class-based priority includes assigning a higher priority to rtPS flows than nrtPS flows, which are higher priority than BE flows. Additionally, a transmission-direction-based priority is implemented where downlink traffic is assigned a higher priority than uplink traffic. Assigning a higher priority to downlink traffic allows a base station to relay packets as soon as possible to avoid buffer overflow and guarantee latency requirements. In this example, downlink rtPS has the highest priority followed by uplink rtPS. Next, the nrtPS downlink flows have a higher priority than uplink nrtPS flows. Lastly, downlink BE flows have a higher priority than uplink BE flows.

An active service flow list is maintained in a base station. The DFPQ only schedules the bandwidth application services in the active list. If a queue is not empty, it remains in the active list. Otherwise, the queue is removed from the active list. The service flows in the active list are queued according to the strict priorities in the previous paragraph. In each round, the highest priority flow will always be served first.

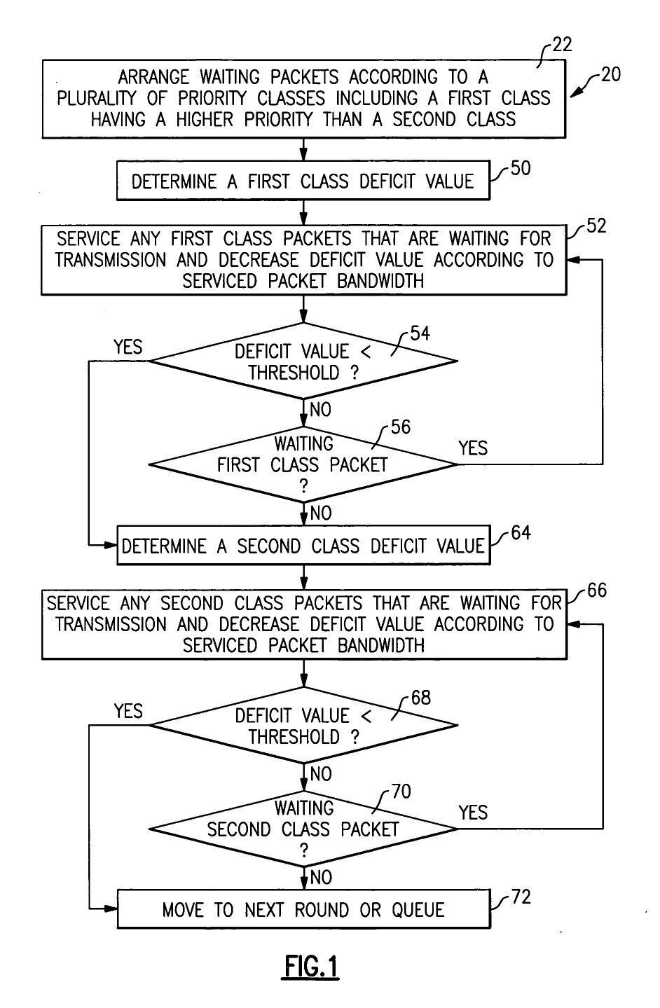

The flowchart 20 in FIG. 1 includes a step at 22 for arranging packets that are waiting for service according to a plurality of priority classes. For example, a first class downlink rtPS flow has a higher priority than a second class downlink BE flow. One example includes an admission control mechanism that determines whether a new request for a connection can be granted or not according to a remaining free bandwidth. Whether a new request is granted determines whether the associated packets make it into a queue for servicing. In one example, the base station has an admission control policy that determines whether a quality of service of a connection can be satisfied. The admission control policy ensures that the existing connection quality of service will not be degraded significantly and the new connection quality of service will be satisfied. One example admission control includes collecting all of the DSA, DSC and DSD requests and updating the estimated available bandwidth based on the associated bandwidth change. For example, where there are I classes of service and the i^{th} classes of service have a total of Jᵢ connections, the available bandwidth can be described by the following equation:

$${C}_{a} = {C}_{total} - {\sum }_{i = 1}^{I} {\sum }_{j = 1}^{{J}_{i}} {r}_{min} ( i , j )$$

This example includes using a minimum reserved traffic rate as part of determining the available bandwidth (Cₐ). rₘᵢₙ(i,j) is the minimum reserved traffic rate of the j^{th} connection in the i^{th} class of service flow. Cₜₒₜₐₗ is the total capacity of the wireless link. For connections having rₘᵢₙ equal to 0, they will always be accepted by this example admission policy. Quality of service for such connections will not be guaranteed, however. They always have the lowest priority in one example. Such a connection will be interrupted any time unless the quality of service requirements of all other connections can be sufficiently met. In one example, a new flow or a change to an existing flow will only be accepted if the total available bandwidth Cₐ is greater than or equal to 0.

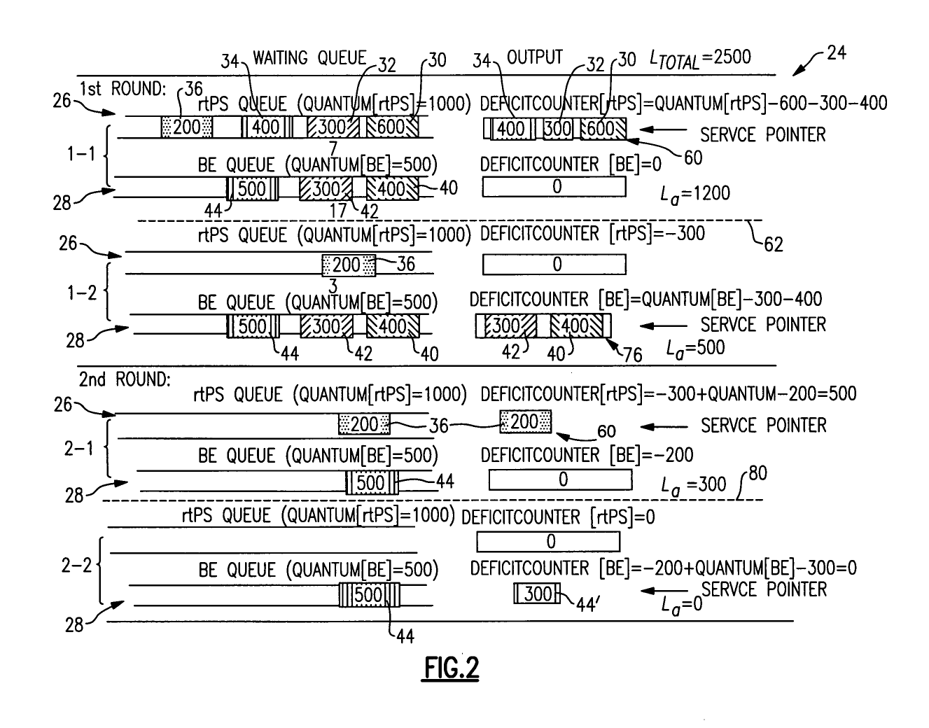

FIG. 2 graphically illustrates an example plurality of waiting packets that have been admitted because the available bandwidth requirements described above have been satisfied. The waiting packets have been arranged according to a plurality of priority classes. The rtPS class packets are arranged in a first class queue at 26 in FIG. 2. The BE class packets are arranged in a second class queue 28.

In this example, four rtPS flows (represented by the illustrated packets) are waiting for service including a first packet 30 having a 600 bit bandwidth request, another packet 32 having a 300 bit bandwidth request, a next packet 34 having a 400 bit bandwidth request and a packet 36 having a 200 bit bandwidth request. The plurality of packets of the BE priority at 28 includes a packet 40 having a 400 bit bandwidth request, a packet 42 having a 300 bit bandwidth request and a packet 44 having a 500 bit bandwidth request.

The queues 26 and 28 includes waiting flows and, therefore, are on the active list. When the scheduler visits the queues in the active list, it first attempts to service the packets within the first priority queue 26. The scheduler in one example determines the number of requests in the queue 26. A first class deficit value, which in this example is referred to as a deficit counter, is incremented by a quantum value each time the queue 26 is visited by the scheduler. In one example, the quantum value Quantum(i) for the i^{th} class of service flow is determined from the following equation:

$$Quantum [ i ] = {\sum }_{j = 1}^{{J}_{i}} {r}_{max} ( i , j )$$

Where Jᵢ is the total number of connections for the i^{th} class of service flow. In one example, rₘₐₓ will be set to rₘᵢₙ for a connection that does not have a specified rₘₐₓ in the equation (if rₘᵢₙ is not specified either, then rₘₐₓ=rₘᵢₙ=0). The service rate of the connection that has the larger value for Quantum will be higher than the smaller one. In other words, connections having a specified value for rₘₐₓ will have better performance than those with a smaller rₘₐₓ.

Referring to FIG. 2, the scheduler visits the queue 26 during a TDD frame 24 having a total capacity of 2500 bits. Because the queue 26 includes waiting first class, rtPS packets, it is on the active list. The available capacity of the frame 24 begins at the total capacity. The first class deficit value begins at the quantum value for the highest priority flow waiting in the queue 26. In this example, Quantum for the rtPS flows is 1,000. Accordingly, the deficit value is initially set to 1,000. This is shown at 50 in FIG. 1.

The process in FIG. 1 continues at 52 by servicing any of the highest priority or first class packets that are waiting for transmission. The deficit value is decreased according to a serviced packet bandwidth (e.g., a bandwidth request amount of a packet at the head of the queue). The decreased deficit value is then compared to a threshold at 54. If the deficit value exceeds the threshold, a determination is made at 56 whether there are any remaining waiting first class packets. If so, the next in line packet is serviced at 52.

In one example, the threshold for the deficit value is 0 such that any time the deficit value is less than or equal to 0, that will stop the servicing of the first class packets in that queue for that round. Whenever the deficit value falls below the selected threshold or there are no remaining waiting first class packets, the process proceeds to the next highest priority service flow type.

Referring to FIG. 2, for example, the 600 bit bandwidth request packet 30 at the head of the rtPS queue 26 is smaller than the value of the first class deficit counter, which was initialized at 1,000. Accordingly, the 600 bit bandwidth request is serviced and moved to the service pointer schematically shown at 60. This causes the first class deficit value to be decremented by 600 bits, resulting in a new value of 400. The next in line bandwidth request packet 32 is a 300 bit bandwidth request, which is smaller than the 400 current value of the deficit counter. Accordingly, the 300 bit packet can be serviced and is moved to the service pointer at 60.

Now the first class deficit value is 100 bits. In this example, the threshold is 0 so that servicing the highest priority (e.g., rtPS) flows continues. The next bandwidth request packet 34 has a 400 bit bandwidth request. This connection is serviced and moved to the service pointer at 60. The resulting first class deficit value is −300 (e.g., 100−400=−300). At this point, the deficit value has fallen below the threshold (e.g., 0). The scheduler proceeds to the next highest priority queue at 62.

According to the example DFPQ, the next highest priority flows within the queue 28 will now be serviced. In the example of FIG. 2, the BE connections at 28 will be serviced. Prior to servicing those connections, the second class deficit value is updated in an amount corresponding to the Quantum value for BE flows. This is shown at 64 in FIG. 1. The procedure for serving the second class packets is similar to that used for the first class packets as just described. In FIG. 1, the step at 66 includes servicing any second class packets that are waiting for transmission and decreasing the second class deficit value according to a serviced packet bandwidth request amount. The deficit value is compared to a threshold as each packet is serviced at 68. If the deficit value still is above the threshold, a determination is made at 70 whether there are any remaining waiting second class packets. Once the second class deficit value is below the threshold or there are no more remaining waiting second class packets, the scheduler moves to the next round or the next queue at 72.

In this example, the second class deficit value for the BE packets is initialized at the Quantum value of 500. The bandwidth request packet 40 at the head of the queue requires 400 bits, which is less than the 500 bit value of the deficit counter. Accordingly, the packet 40 is moved to the service pointer schematically shown at 76. The BE deficit value is decreased by 400, which results in a value of 100. This value is over the threshold (e.g., 0) so that the next packet 42 can be serviced. In this example, the packet 42 includes a 300 bit bandwidth request, which is moved to the service pointer at 76. The deficit counter is decreased by 300 so that the result is −200. At this point, the BE deficit value is below the selected threshold and the scheduler moves to the next round or the next queue.

In the example of FIG. 2, the queue 26 is still on the active list because there are remaining connections waiting for service. In the second round, the rtPS flow is still the highest priority. The deficit counter value for the rtPS flows is updated by the Quantum value for rtPS flows (e.g., 1,000). In this example, the first class deficit value begins at −300+1,000=700 for the second round. The 200 bit bandwidth request of the packet 36 can be processed now. The packet 36 is moved to the service pointer at 60. The deficit counter value is then decreased by 200 bits, resulting in a 500 bit value. At this point, there are 300 remaining bits for the TDD frame and no remaining waiting rtPS class packets.

The scheduler then moves on to service the BE flows. This is schematically shown at 80 in FIG. 2. At this point, the BE deficit value is updated by the Quantum amount 500. The second class deficit value is now −200+500=300. In this example, there are only 300 bits remaining in the TDD frame capacity. The subscriber station fragments the 500 bit packet 44 to transmit the first 300 bit subframe leaving a 200 bit subframe to apply for transmission in the next TDD frame. The 300 bit subframe 44′ is moved to the service pointer at 76 and the scheduling for this frame is complete.

Once the processing of a frame is completed, the active list is updated and the scheduling continues.

In one example scheduling process of FIG. 1, the connections in the waiting queue are serviced one by one according to priorities as described above until there is no available bandwidth left or it is time for sending an MAP message. In other words, processing continues for a current highest class until at least one of the following conditions is satisfied: (1) the deficit counter value for that priority is below the selected threshold, (2) the bandwidth request waiting queue is empty or there are no remaining waiting packets of that service class, (3) there is no available bandwidth left, or (4) it is time to send a MAP message.

As can be appreciated from this example, in each service round, the highest priority queue will be served first until its assigned bandwidth is deficit. This makes the disclosed example a priority queue based scheduling. On the other hand, if the assigned bandwidth is deficit for the higher priority queue, a service flow with a lower priority in the waiting queue has a chance to be served, which provides a fair solution for a lower priority queue. This differs from a strict priority queuing. Accordingly, the disclosed example is referred to as deficit fair priority queuing (DFPQ).

One example includes a second layer scheduling technique. Each of the different classes of connections can be serviced using an algorithm to match the quality of service requirements for that type of connection. In one example, rtPS connections are served using an earliest deadline first technique for ordering the packets within a queue. Packets with the earliest deadline will be scheduled first. An information module determines each packet's deadline and calculates an arrival time and maximum latency as part of the earliest deadline first approach.

In one example, nrtPS connections are served using weight fair queuing (WFQ) which includes scheduling nrtPS packets based on a ratio between a connection's nrtPS minimum reserved traffic rate and the total sum of the minimum reserved traffic rate of all nrtPS connections.

In one example, the remaining bandwidth is allocated to each BE connection using a round-robin (RR) technique.

One example includes a buffer management technique that is used to control the buffer side and decide which packet to drop. In the case of WFQ and RR scheduling, a first input, first output queue for each priority service can be deployed. For EDF scheduling, since time sensitive traffic has maximum delay requirements, the buffer management will drop those packets that exceed their maximum latency, which otherwise directly contributes to packet loss rate. Those skilled in the art who have the benefit of this description will realize that a buffer length can be set according to a particular implementation's requirements.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising:
scheduling packets for transmission using deficit fair priority queuing.

2. The method of claim 1, comprising
arranging packets waiting for service according to a plurality of priority classes including a first class having a higher priority than a second class;
determining a first class deficit value;
servicing any first class packets that are waiting for transmission before servicing any second class packets and adjusting the first class deficit value accordingly until at least one of
the first class deficit value is below a selected threshold, or
there is no remaining waiting first class packet;
after the first class deficit value is below the selected threshold or there is no remaining waiting first class packet, determining a second class deficit value; and
subsequently servicing any second class packets that are waiting for service and adjusting the second class deficit value accordingly until at least one of
the second class deficit value is below the selected threshold, or
there is no remaining waiting second class packet.

3. The method of claim 2, wherein the plurality of priority classes includes a third class having a lower priority than the second class and comprising
after the second class deficit value is below the selected threshold or there is no remaining waiting second class packet, determining a third class deficit value; and
subsequently servicing any third class packets that are waiting for service until at least one of
the third class deficit value is below the selected threshold, or
there is no remaining waiting third class packet.

4. The method of claim 2, comprising
adjusting the first class deficit value in an amount corresponding to the first class before servicing any of the first class packets;
decreasing the first class deficit value each time that a first class packet is serviced in an amount corresponding to a bandwidth requirement of the serviced first class packet;
subsequent to servicing the last of the serviced first class packets, adjusting the second class deficit value in an amount corresponding to the second class before servicing any of the second class packets; and
decreasing the second class deficit value each time that a second class packet is serviced in an amount corresponding to a bandwidth requirement of the serviced second class packet.

5. The method of claim 2, wherein
the amount corresponding to the first class for adjusting the deficit value is a function of a traffic rate of all connections for the first class;
the amount corresponding to the second class for adjusting the deficit value is a function of a traffic rate of all connections for the second class.

6. The method of claim 5, wherein
the traffic rate for each of the classes comprises at least one of a maximum sustained traffic rate or a minimum reserved traffic rate for the corresponding class.

7. The method of claim 2, wherein the selected threshold is zero.

8. The method of claim 2, comprising
performing as many as possible of the steps of claim 2 within a frame; and
repeating the performing within the frame until at least one of
there is no remaining available bandwidth for the frame, or
a time to send a MAP message arrives.

9. The method of claim 8, comprising
adjusting the deficit value for at least one of the classes each time that a queue having waiting packets from the at least one of the classes is visited within the frame.

10. The method of claim 2, comprising
determining an available bandwidth before servicing each next waiting packet from a difference between the total bandwidth of a frame during which the packets will be serviced and an aggregate bandwidth associated with any packets that have been serviced during the frame.

11. The method of claim 11, comprising
ordering the arranged packets of each of the plurality of classes according to an order corresponding to each class, respectively.

12. The method of claim 11, comprising
ordering the first class packets using an earliest deadline first order; and
ordering the second class packets using a weight fair queue order.

13. The method of claim 2, comprising
assigning a higher priority to downlink traffic relative to uplink traffic in each of the priority classes such that first class downlink traffic has a higher priority than first class uplink traffic, which has a higher priority than second class downlink traffic.

14. The method of claim of claim 1, comprising
transmitting packets over a wireless broadband connection in a time division duplexing mode, based upon the deficit fair priority queuing.

15. The method of claim 1, comprising
admitting a new flow to be scheduled using the deficit fair priority queuing based upon a relationship between a minimum reserved traffic rate of all admitted flows and an available bandwidth for servicing the admitted flows.

16. The method of claim 1, comprising
assigning a higher priority to downlink traffic than uplink traffic.
